(19) United States
(12) Patent Application Publication
(10) Pub. No.: US 2003/0065650 A1
(43) Pub. Date: Apr. 3, 2003

(54) Method and query application tool for searching hierarchical databases

(76) Inventors: Ritchie I. Annand, Calgary (CA); Garry E. Perry, Calgary (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/968,922

(22) Filed: Oct. 3, 2001

(51) Int. Cl. G06F 7/00

(52) U.S. Cl. 707/3

(57) ABSTRACT

A query application tool for a document-based database management system where data entries are stored in database tables of a database and wherein data entries are exposed through documents including data controls live linked to the database tables includes a query arbiter responsive to a specified query to search the database tables for data entries that satisfy the specified query and generate query results. A query filter restricts the display of data entries in an active document so that only data entries in the query result that correspond with data controls in the active document are displayed.

### FIELD OF THE INVENTION

The present invention relates generally to database searching and in particular to a method and query application tool for searching hierarchical databases.

### BACKGROUND OF THE INVENTION

Searching databases for information is common and many software applications provide search or query application tools to enable users to search stored data to locate information of interest within the databases. Although query application tools allow information of interest to be located within databases, problems exist in that the information returned during queries in many instances does not facilitate application and/or visualization of the query results.

Depending on the type of database being searched and the query operations specified in the search, the severity of the above-identified problems can vary. The above identified problems are particularly evident in the case of relational or hierarchical databases. For example, SQL provides a search facility that allows searches across database tables to be performed by writing appropriate SQL statements and setting up the necessary joins between the database tables. Running such an SQL statement returns a table that includes different columns holding the data specified in the search. Unfortunately, writing SQL statements that include the necessary joins between the database tables can be very difficult in the case of complex searches. Also, if many database tables are included in a search, the search results may include a significant number of duplicate entries as a result of Cartesian joins. These duplicate entries, in combination with the table approach used to display the search results, make the search results difficult to apply and visualize. As will be appreciated, improvements in hierarchical database searching are desired.

It is therefore an object of the present invention to provide a novel method and query application tool for searching hierarchical databases.

### SUMMARY OF THE INVENTION

According to one aspect of the present invention there is provided in a document-based database management system where data entries are stored in database tables of a database and wherein data entries are exposed through documents including data controls live linked to said database tables, a query application tool comprising:

a query arbiter responsive to a specified query to search the database tables for data entries that satisfy said specified query and generate query results; and

a query filter to restrict the display of data entries in an active document so that only data entries in said query result that correspond with data controls in said active document are displayed.

Preferably, the database is hierarchical and the query filter generates filters relative to the hierarchy of the database. It is also preferred that the generated filters are displayed via a graphical user interface in a visual hierarchy that provides a visual indication as to the location of the query results within the hierarchical database. The graphical user interface also allows the generated filters to be selectively enabled and disabled.

Preferably, the query arbiter creates query agents to perform the searches of the database. The specified query includes at least one query operation and at least one query container. The query arbiter firstly creates a query agent to execute the at least one query operation and generate a result set. The query arbiter then creates a query agent to execute the at least one query container and generate a result set. The result set is then grown to the top of the database.

According to another aspect of the present invention there is provided in a document-based database management system where data entries are stored in database tables of a database and wherein data entries are exposed through documents including data controls live linked to said database tables, a method of displaying data entries in said database tables that satisfy a specified query in an active document comprising the steps of:

examining a specified query and searching said database to locate data entries satisfying said specified query thereby to generate a query result;

generating filters to restrict the display of data entries to data entries in said query result; and

displaying data entries in said query result that correspond with data controls included in said active document.

According to yet another aspect of the present invention there is provided a method of searching first and second result sets extracted from a hierarchical database for data entries in said database that satisfy search criteria, said method comprising the steps of:

equalizing said first and second result sets; and

examining said equalized first and second result sets based on said search criteria for data entries in said equalized first and second result sets that satisfy said search criteria.

According to still yet another aspect of the present invention there is provided a query filter to restrict the display of data entries stored in a hierarchical database that are live linked to data controls in an active document, said query filter comprising:

a plurality of filters generated in response to a query to restrict the display of data entries corresponding with data controls of said active document to those data entries that satisfy said query; and

a graphical user interface to display the generated filters.

The present invention provides advantages in that hierarchical databases can be searched effectively using complex query operations. Also, data is returned by searches in a manner that facilitates application and visualization of the query results since the query results are presented to the user within the user-specific documents created for that user. In addition, since the query application tool displays the hierarchy of the filters used to restrict displayed data to database entries that satisfy the specified query, a visual indication of the location of the query results relative to the model representing the business entity is provided.

### BRIEF DESCRIPTION OF THE DRAWINGS

An embodiment of the present invention will now be described more fully with reference to the accompanying drawings in which:

FIG. 1 is a schematic block diagram of a document-based database management system including a query application tool in accordance with the present invention;

FIG. 2 are flowcharts illustrating the general steps performed by the document-based database management system of FIG. 1 when used to develop a visual model of a business entity and corresponding data schema, create documents using the data schema and populate database tables using the created documents;

FIG. 3 is a screen display showing a visual model of a business entity in the form of an Oil Company;

FIG. 4 is a screen display showing a workbook created for the Oil Company that includes a document selection panel and an active document panel presenting a daily drilling report document;

FIG. 5 is a screen display showing a daily drilling descriptions data field that forms part of the daily drilling report document of FIG. 4;

FIG. 6 is a screen display showing a query window specifying a query to be performed;

FIGS. 7a and 7b are flowcharts showing the steps performed by the query application tool during a query;

FIG. 8 is a functional block diagram showing a query arbiter and query agents created by the query application tool during a query;

FIG. 9 is a screen display showing the daily drilling descriptions data field presenting database table entries returned by the query application tool after performing the query specified in FIG. 6;

FIG. 10 is a screen display showing a query filter window generated by the query application tool in response to the query specified in FIG. 6;

FIG. 11a is a screen display showing an alternative visual model of a business entity;

FIGS. 11b and 11c show models and primary keys associated with database entries in database tables created for the model of FIG. 11a;

FIGS. 12a and 12b show a document in the active document panel of a workbook exposing database entries corresponding to the primary keys illustrated in FIGS. 11b and 11c;

FIG. 13 is a screen display showing a query window specifying another query to be performed;

FIG. 14 shows result sets returned by query agents during performance of the query specified in FIG. 13;

FIGS. 15a to 15d illustrate equalization of result sets during performance of the query specified in FIG. 13;

FIG. 16 is a flowchart showing the steps performed by the query application tool during result set equalization;

FIG. 17 is a screen display showing a query filter window generated by the query application tool in response to the query specified in FIG. 13; and

FIG. 18 is a screen display showing the document of FIGS. 12a and 12b presenting database table entries returned by the query application tool after performing the query specified in FIG. 13.

### DETAILED DESCRIPTION OF THE PREFERRED EMBODIMENTS

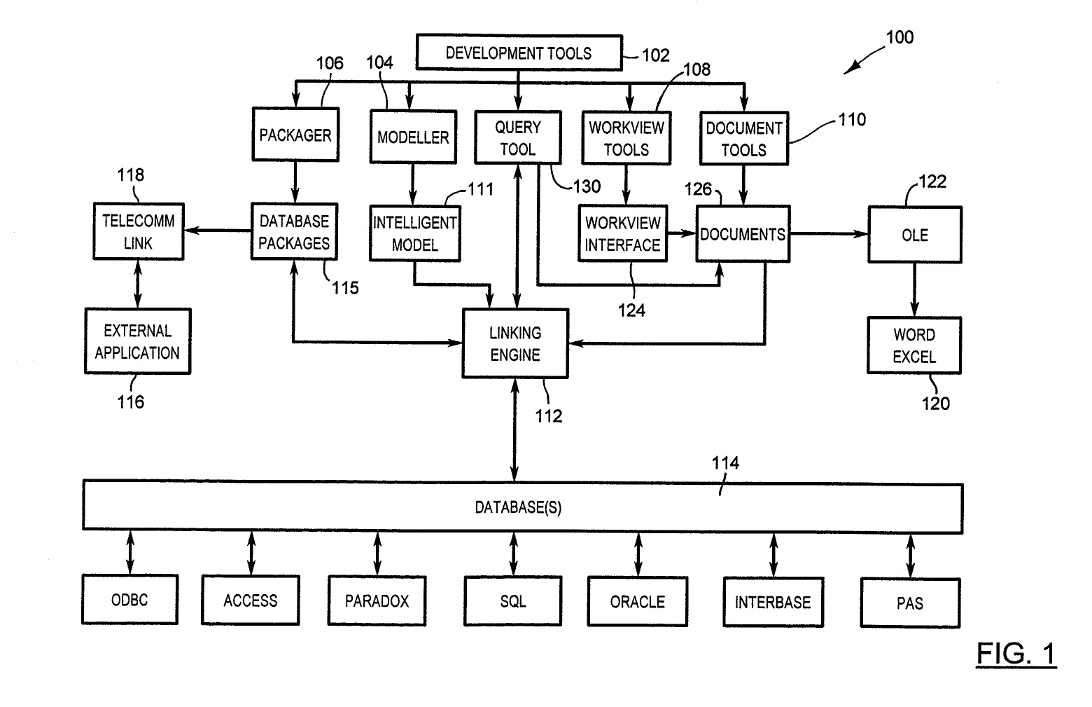

Turning now to FIG. 1, a functional schematic block diagram of a document-based database management system such as that described in Applicants' co-pending U.S. patent application Ser. No. 09/553,959 filed on Apr. 21, 2000 entitled “Document-Based Database Management System And Method”, the content of which is incorporated herein by reference, is shown and is generally identified by reference numeral 100. As can be seen, the document-based database management system includes a set of development tools 102 that are accessed by a modeller 104, a packager 106, workview tools 108 and document tools 110. The document-based database management system 100 also includes graphical user interfaces to allow developers and end-users to interact with the functional components of the document-based database management system 100. In the preferred embodiment, the document-based data management system is written in Borland's Delphi Enterprise that is distributable across standard Windows '95, '98, 2000, ME and NT platforms. As is well known, Delphi is object-oriented software that facilitates Windows development using drag-and-drop visual programming. Delphi provides excellent database support, strong object-orientation and high productivity.

Modeller 104 allows a developer to create an acyclic directed graph or intelligent hierarchical model 111 of an entity such as a business, organization or other entity of interest (hereinafter referred to as “business entity”). The modeller 104 also translates the hierarchical model into a database table structure for a selected backend relational database 114.

Packager 106 includes an export/import function and creates database packages 115 that are to be conveyed to another computer site 116 over a telecommunications link 118. Database packages 115 received by the packager 106 are unpackaged and are then conveyed to a linking engine 112, which in turn reconciles the data in the database packages with the data in the backend database 114.

Workview tools 108 and document tools 110 allow the developer to create user-specific workviews that contain user-specific documents 126. The document tools 110 create objects that are used by the linking engine 112 to live-link data controls in the documents 126 to the database 114. In this manner, data entered into the fields of the data controls automatically populates the backend database 114. Thus, data visible in a document through a data control is in the backend database 114. In this particular embodiment, the linking engine 112 interfaces with ODBC or SQL backend databases such as Paradox, Oracle, Interbase, and SQL Server to name a few. Those of skill in the art will however appreciate that the linking engine 112 may be designed to interface with other backend databases if desired. The documents 126 also interact with other applications 120 via an OLE interface 122.

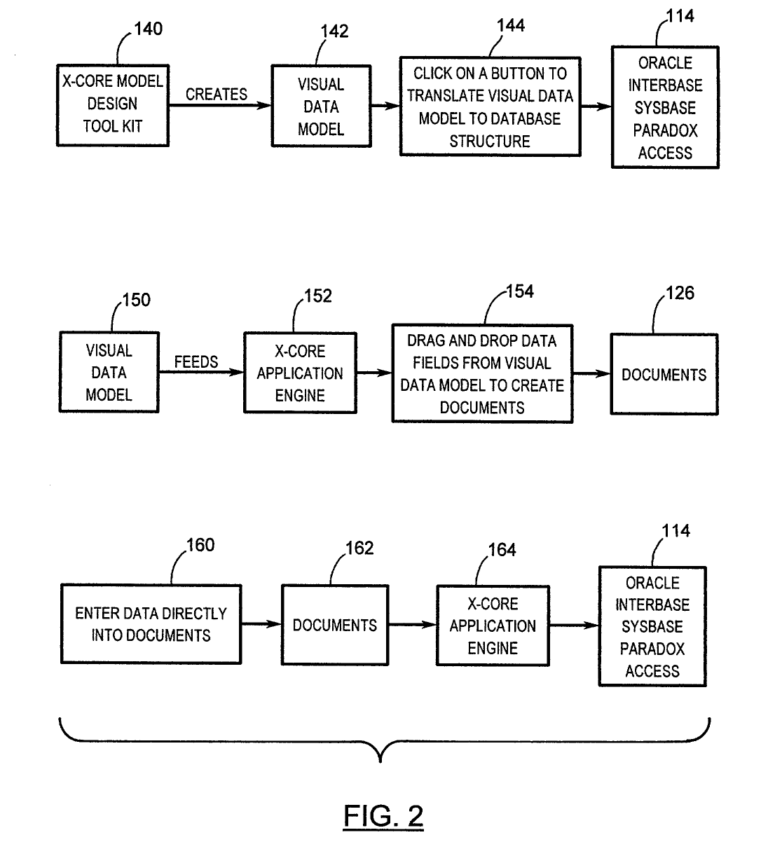

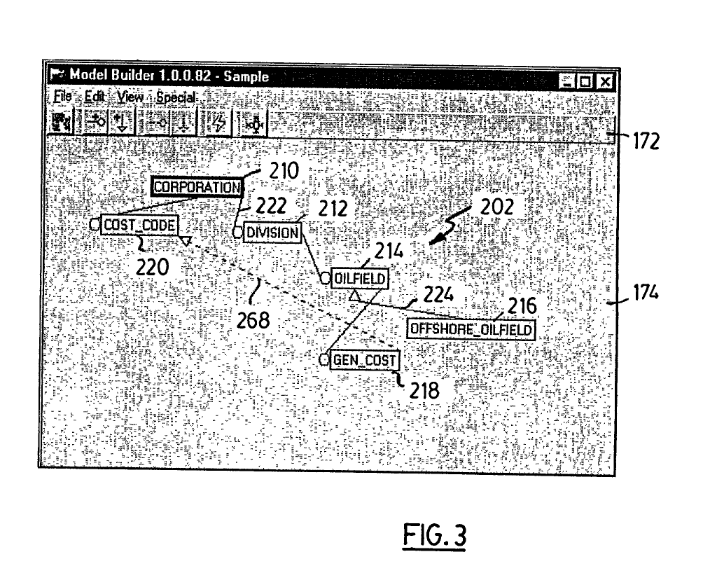

The document-based management system 100 also includes a query application tool 130. Query application tool 130 communicates with the selected backend database 114 through the linking engine 112 and with documents 126. The query application tool 130 allows the backend database 114 to be searched for specified database entries and allows database entries located in the query to be displayed through documents 126. The general overall operation of the document-based database management system 100 will now be described with reference to FIGS. 2 and 3.

Initially, the developer uses the modeller 104 to develop a hierarchical model that represents the business entity and its information requirements. The model is developed visually using entity-relationship diagrams. Using the modeller 104, an entity within the business entity is created and displayed on a model creation palette 174 (see FIG. 3) and attributes are assigned to the entity. A second entity is then created or dragged and dropped onto the model creation palette 174 and its relationship to the first entity is defined graphically. This process is performed until a complete visual model 111 of the business has been created (blocks 140 and 142).

FIG. 3 shows the model creation palette 174 presenting a visual model 202 representing an Oil Company. In this particular example, the model 202 includes a corporation entity 210, a division entity 212, an oilfield entity 214, an offshore_oilfield entity 216, a gen_cost entity 218 and a cost_code entity 220. The connections between the entities in the model 202 visually indicate whether an entity adds detail to an entity above it or is derived from an entity above it. In the present embodiment, “one to many” relationships between entities are denoted by blue lines terminating in circles while “is derived from” relationships between entities are denoted by green lines beginning with triangles. As can be seen, in this example, the division entity 212 and the cost_code entity 220 add detail to the corporation entity 210. The oilfield entity 214 adds detail to the division entity 212. The offshore_oilfield entity 216 on the other hand is derived from the oilfield entity 214 (i.e. the offshore_oilfield is an (IS-A) oil field).

Those of skill in the art will appreciate that the size and complexity of the visual model 202 has been reduced for ease of illustration. A complete visual model 202 representing an Oil Company would typically include a number of corporate divisions, each responsible for a number of oilfields. The visual model 202 would also typically include entities associated with other physical categories within the Oil Company such as for example, the seismology department and the accounting department etc. to name a few.

Once the visual hierarchical model is complete, a backend database is selected and a table generator in the modeller 104 is conditioned to translate the visual model 111 into underlying hierarchical database tables (i.e. the data schema) that correspond to the model for the selected backend database 114 (block 144). Once the backend database has been selected, the database tables for the visual model that are compliant with the selected backend database are generated. Specifically, the modeller 104 generates the appropriate hierarchical database tables for the selected backend database using the entities, attributes and entity-relationships within the visual model. Since the hierarchical database corresponds to the hierarchy of the model, records stored in the database tables are stored in a manner that tracks the structure of the business entity.

Each entity in the hierarchical model is assigned a primary key attribute (Xprime), a last altered date (Xaltered), a last arrived date (Xarrived) and a master key to its master entity. The attributes and dates are used to support a low-bandwidth distributed database as is described below.

The primary key attribute acts as a modified “auto-increment” and is the sole identifier of a record of data throughout the entire distributed database. The primary key attribute is used to keep different records from overwriting one another. To inhibit different records from overwriting each other, a block of key numbers is pre-allocated to each different user and is termed the user license. In this particular embodiment, the user license grants a user 28 keys with which to enter data into the backend database 114. The primary key attribute is a 32-bit integer that includes an upper part and a lower part. The upper part of the integer is the user license number. The lower part of the integer is an auto-increment, and increments by one for each new record created by the user for a given entity within the model, until the upper limit is reached. When the upper limit is reached and the user attempts to add a new record to the backend database, the user is presented with a message stating “This user license has completely run out of keys”. The user can then be assigned a new unique user license for a new range of keys allowing the user to continue to create new records.

Since auto-increment field behavior is inconsistent amongst databases (for example, Paradox only lets fields begin from one, and does not let different users working on the same database start from different spots), and since the auto-increment values are typically only available after a record has been posted to the central database, the linking engine 112 keeps track of the auto-increments on its own, and keeps the primary keys as simple long integers. In case of an improper shutdown, a value that is zeroed, only when the database management system 100 exits improperly, can indicate that a “key recovery” needs to be done. During a key recovery, the linking engine 112 finds the highest value in the pre-allocated primary key range that already exists, and auto-increments from there as new records are created.

The number of primary keys allocated for each user license is per entity and not all entities together. This is permissible since the records only have to be unique across the distributed database in each database table, not across all database tables. As a result, the limiting factor for a given user license is the largest number of records entered for any entity.

The last altered date includes a date/time field and acts as a “stamp” to allow modifications to particular records to be tracked. When records are received by the central primary computer site from remote computer sites, the last altered date allows the linking engine 112 to determine if the data is newer than entries in the central database, in which case the data is applied, or whether the data is older or the same date as entries in the central database, in which case the data is ignored.

The last arrived date represents the time that a given piece of data arrives at the central database. For records created or modified on the central primary computer site 116, the last altered date and the last arrived date assigned to the records are the same. For records that are received by the central primary computer site from a remote computer site, the last arrived dates are set to the time at which the records are unpackaged by the packager 106. Thus, the differences between the last altered dates and last arrived dates indicate the length of time the records have been “out” of the central database. The last arrived dates are used when it is desired to search a database for new records during a print new or export new task. Further specifics of the model and the hierarchical database table creation processes are described in Applicants' co-pending U.S. application Ser. No. 09/553,959, incorporated herein by reference, and therefore these processes will not be described further herein.

After the database tables are created, the developer uses the document tools 110 and the data schema to create documents 126 for the end-users in the business entity. During this stage, the data schema (i.e. the entities and their attributes in the model) is presented in a window adjacent an active document. Data control types are selected and attributes from the data schema that are to form part of the active document are dragged and dropped into the active document (block 154). Data controls of the selected types and associated with the attributes dropped into the active document are automatically created and are live-linked to the appropriate database tables of the backend database 114 through objects. This document creation process is continued until a full suite of documents is created that services all of the end-users of the business entity.

The development tools 102 include a full suite of data-aware control icons including for example: columns, data fields, graphs, sketches, pictures etc. so that various types of data controls can be included in each document. The workview tools 108 provide tools to allow the developer and end-users to control the overall manner in which documents are presented to end-users. As a result, the development tools 102 and the workview tools 108 allow the visual appearance of the documents 126 and the manner and types of data controls in the documents to be effectively tailored to suit the needs of the end-users for whom the documents are created. Since the documents 126 are created specifically for end-users, the documents reflect the end-users' views of the business model and are the users' gateways to the business model. The documents therefore control who is able to access what corporate data and how the corporate data is accessed.

Once the documents are created, the documents 126 are arranged within workbooks according to user work requirements. The database management system 100 including the model, the database tables and the various workbooks is then installed on the computer sites throughout the distributed data network of the business entity. The documents can then be used to populate the database with data. Since the data controls in the documents 126 are live-linked to the appropriate database tables of the backend database 114 by the linking engine 112, as data is entered into the fields of the data controls (blocks 160 and 162), the linking engine 112 automatically populates the database tables of the backend database 114 with the entered data (block 164). Records stored in the databases at remote computer sites that include new data are packaged by the packager 106 and are conveyed over a telecommunications link 118 to the central primary computer site of the business entity. The packages are then imported by the packager 106 at the central primary computer site and are depackaged. Once depackaged, the records are reconciled with the central database by the linking engine 112. In this manner, all information entered into databases throughout the distributed data network can be reconciled in the database at the central primary computer site. This distributed information can then be effectively aggregated and used by users to make educated decisions. Further specifics of the document and workbook creation processes are described in Applicants' co-pending U.S. application Ser. No. 09/553,959, incorporated herein by reference, and therefore these processes will not be described further herein.

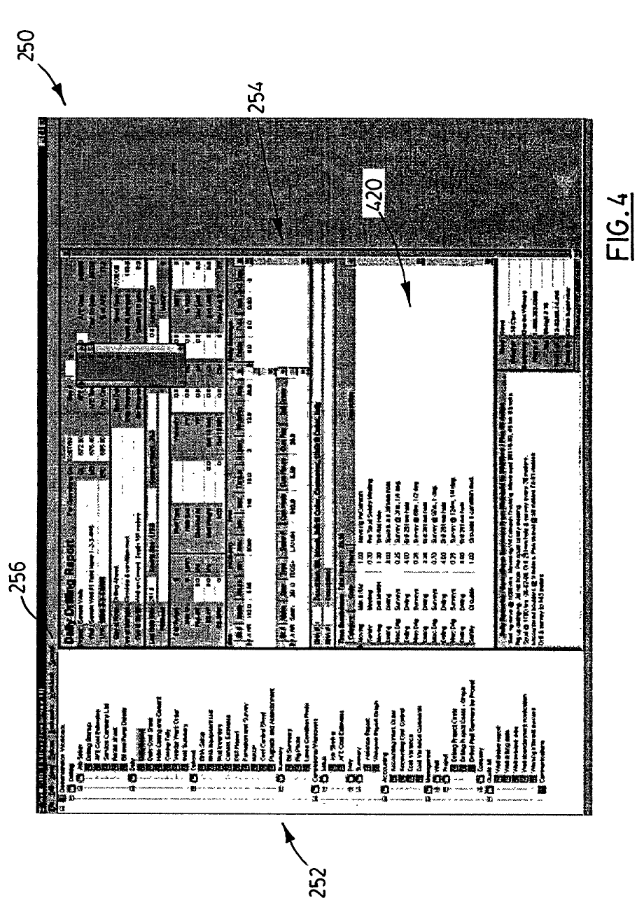

FIG. 4 shows a workbook created for the Oil Company. As can be seen, the workbook 250 includes a document selection panel 252 and an active document panel 254. The document selection panel 252 visually presents the folders in the workbook and the user-specific documents within the folders. In this example, the workbook includes a variety of documents arranged in folders and sub-folders for an oilfield entity of the Oil Company. As can be seen, the document selection panel 252 includes a workbook having a drilling folder, a completions/workovers folder, an accounting folder, a management folder, a guide folder and a communications folder.

The drilling folder includes four sub-folders namely, a job setup folder, a daily folder, an optional folder and a summary folder. The job setup folder includes a drilling startup document, an AFE cost estimates document, a service company list document, a rental sheet document and a bit and pump details document.

The daily folder includes a daily report document, a daily cost sheet document, a hole, casing and cement document, a casing tally document, a vendor work order document and a well summary document.

The optional folder includes a BHA setup document, a BHA equipment list document, a mud inventory document, a cement estimates document, a DST report document, a formation and survey document, a MACP document, a cost control sheet document and a plugback and abandonment document.

The summary folder includes a bit summary document, a rig photo document and a lease condition photo document.

The completions/workovers folder includes three sub-folders namely, a setup folder, a daily folder and a summary folder. The setup folder includes a job startup document and an AFE cost estimates document. The daily folder is closed, hiding the documents therein from view. The summary folder includes a variance report document and a variance report graph document.

The accounting folder includes an accounting work order document, an accounting cost control document, a cost variance document and a cost variance comments document.

The management folder includes well, project and company sub-folders. The well and company sub-folders are closed hiding the documents therein from view. The project sub-folder includes a drilling project costs document, a drilling projects costs graph document and a drilled well summary by project document.

The guide folder includes a well status report document, a well drilling data document, a well incident data document, a well abandonment notification document and a working interest owners document.

The communications folder includes sub-folders that enable communications sessions to be established between the primary computer site and remote computer sites.

Highlighting a document within a folder presented in the document selection panel 252 of the workbook 250 opens the highlighted document in the active document panel 254. In the present example, the daily drilling report document is highlighted in the document selection panel 252 and therefore, is opened and visually presented in the active document panel 254. Once the document is opened, the user can interact with the document and the database tables via the document-centered user interface.

Since the database tables correspond to the hierarchical model 111 representing the business entity, data is stored hierarchically in the backend database 114. If the model includes multiple branches stemming from the same entity, a document having a data control associated with an attribute of that entity can include a drill-down control associated with the attribute of that entity. Selection of the drill-down control allows one of the various branches to be selected. Once a branch is selected, data exposed in documents in the active document panel 254 corresponds to data related to the selected branch. Thus, the drill-down control allows the hierarchical data to be exposed.

As will be appreciated, these folders and user-specified documents allow information concerning the oil well entity from start to finish to be captured, edited, viewed and printed.

The query application tool 130 allows searches or queries of data stored in the database tables of the hierarchical database to be performed. When a query is to be performed, a query option can be selected from a menu of the main toolbar 256 on the workbook 250.

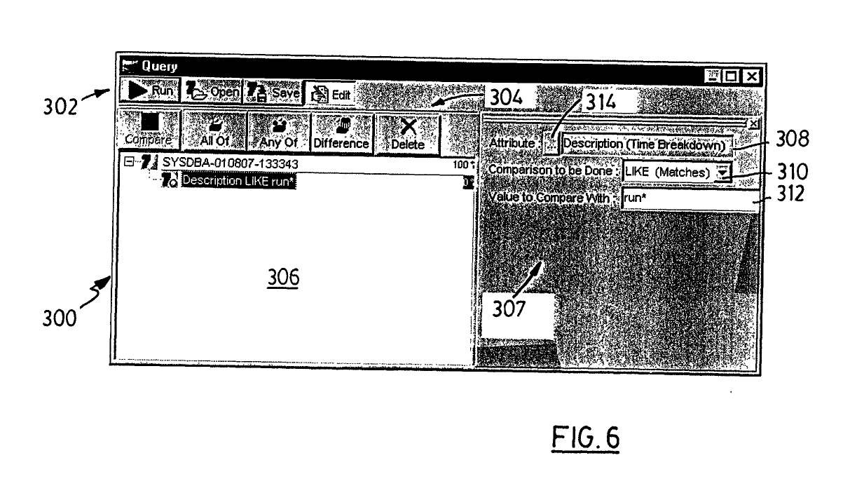

When the query option is selected by a user, a query window 300 is opened as shown in FIG. 6. The query window 300 includes query control buttons 302 including for example run, open, save and edit buttons as well as query type buttons 304 including for example compare, all of, any of, difference and delete buttons. A panel 306 within the query window 300 displays the specified query entered by the user. Each specified query includes at least one query operation and at least one query container. Each query operation includes an attribute, a logical operator and a qualifier. A query container requires result sets either from an underlying query operation or an underlying query container before the query container can be executed. A query container may itself perform a query operation on result sets returned to it or may be a query root container. The query root container corresponds to an entity in the model that is a master of all of the entities whose database entries are examined during a query.

A second panel 307 positioned adjacent the query window 300 allows query operations to be entered into panel 306 by the user and displays details concerning the highlighted query operation or query container in the panel 306. In the example shown, the panel 307 shows the attribute, logical operator and qualifier of the query operation that is highlighted in panel 306 in fields 308 to 312. A button 314 can also be selected to expose the data schema of the hierarchical model 111 in a window allowing query operations in the specified query to be edited or new query operations to be added to the specified query.

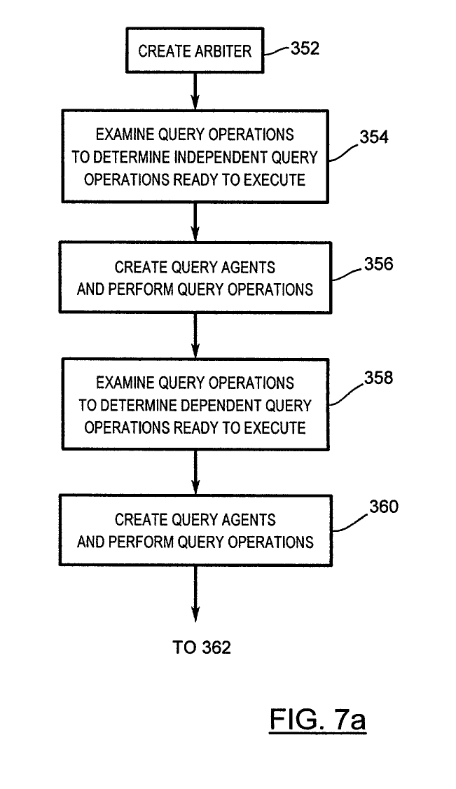

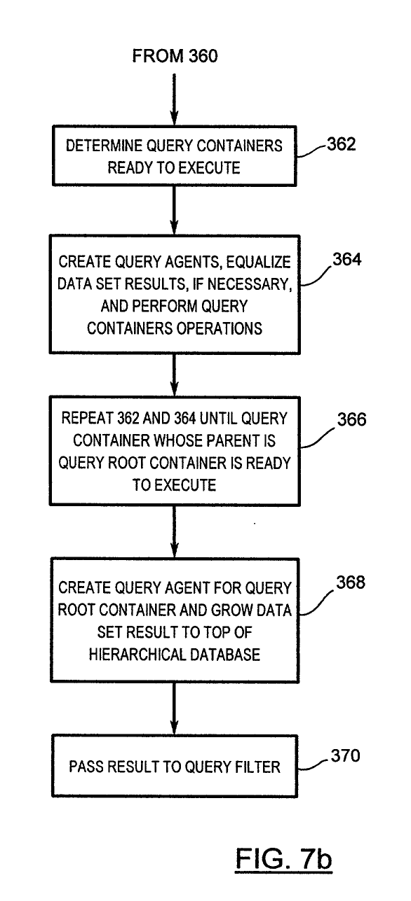

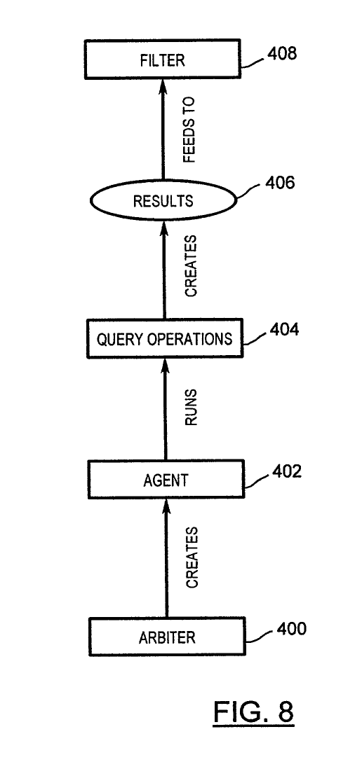

After the specified query has been entered by the user and the run button is selected, the query application tool creates a query arbiter 400 (see block 352 in FIG. 7a and see FIG. 8). Once created, the query arbiter 400, using a bottom-up approach, initially examines the query operations in the specified query to determine the query operations that are ready to execute and can be run independently (i.e. query operations that do not require results from other query operations in order to run) (block 354). These query operations are referred to as independent query operations. The query arbiter 400 in turn creates query agents 402 for the independent query operations. The query agents 402 created for the independent query operations then perform the independent query operations 404 using simple SQL statements based on the attributes, logical operators and qualifiers specified in the query operations (block 356).

During performance of each query operation, the query agent 402 examines the appropriate database tables in the backend 114 database using the attribute, logical operator and qualifier associated with the query operation to determine entries in the database tables that satisfy the query operation. The primary keys associated with the determined database entries are then saved in a container and form a skelton or result set 406. The result set 406 is then returned to the query arbiter 400 by the query agent 402.

After the independent query operations 404 have been performed by the query agents 402, the query arbiter 400 examines the query operations in the specified query to determine if the specified query includes dependent query operations (block 358). A dependent query operation is a query operation that can run independently but requires a large amount of data to be processed. As a result, waiting until result sets are returned by other query operations before performing dependent query operations is beneficial since the result sets returned by other query operations may reduce the amount of data that needs to be processed by the dependent query operations. Query operations that include calculations fall into the dependent query operation category.

If one or more dependent query operations are in the specified query, the query arbiter 400 creates query agents 402 for the dependent query operations. The query agents 402 in turn perform the dependent query operations based on the attributes, logical operators and qualifiers specified in the query operations (block 360). Once the dependent query operations 404 have been performed, the result sets 406 are returned to the query arbiter 400 by the query agents 402.

Once result sets are available for each of the query operations specified in the query, the query arbiter 400 examines the query containers to determine if the specified query includes one or more query containers that perform query operations and that can be run (i.e. those query containers whose child query operations have returned result sets) (block 362). The query arbiter 400 in turn creates query agents 402 for these query containers and the query agents perform the query operations 404 associated with the query containers on the returned result sets (block 364). During this step, the query agents 402 equalize the result sets on which the query operations are to be performed, if necessary, prior to performing the query operations as will be described. Once the query operations are performed, the result sets are returned to the query arbiter 400 by the query agents 402 and the result sets associated with the query containers' children are destroyed to reduce memory resources. This process continues until the query container whose parent is the query root container returns a result set (block 366).

At this stage, the query arbiter 400 creates a query agent 402 for the query root container. The query agent 402 in turn grows the result set returned to the query arbiter 400 by the query root container's child query container up to the top of the hierarchical database and returns the result set to the query arbiter 400 (block 368).

During the growing, the query agent 402 examines each level of the result set to determine if the entity for that level includes a key to a master entity. If not, the result set is deemed complete. However, if the entity for that level includes a key to a master entity, the key to the master entity is added to the result set and the master entity to which the key points is examined to determine if it includes a key to a master entity. This process is repeated until a master entity is reached that does not include a key to a master entity signifying the entity at the top of the hierarchical database.

The result set of the query root container is then passed to the query filter 408 and the query application tool 130 destroys the query arbiter 400 (block 370). The query filter 408 in turn creates appropriate filters so that only the results of the specified query that are included in the result set received by the query filter 408 are exposed through the data controls of the document presented in the active document panel 254. The filters created by the query filter 408 are presented in a filter window and can be turned off and on using a computer-pointing device.

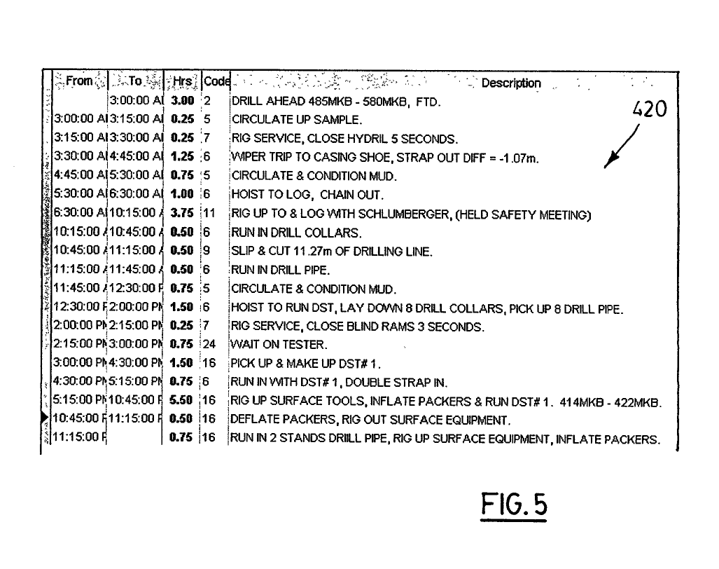

In the example of FIG. 6, the specified query includes a single query operation in the form of a comparison to locate daily drilling report documents having description entries in the descriptions data control field that include the value “run” and a single query container in the form of a query root having the query comparison as its child. The query root container is used to link the result set returned by the query comparison to the top of the hierarchical database. FIG. 5 better illustrates the description data control field 420 of the daily drilling report document shown in FIG. 4.

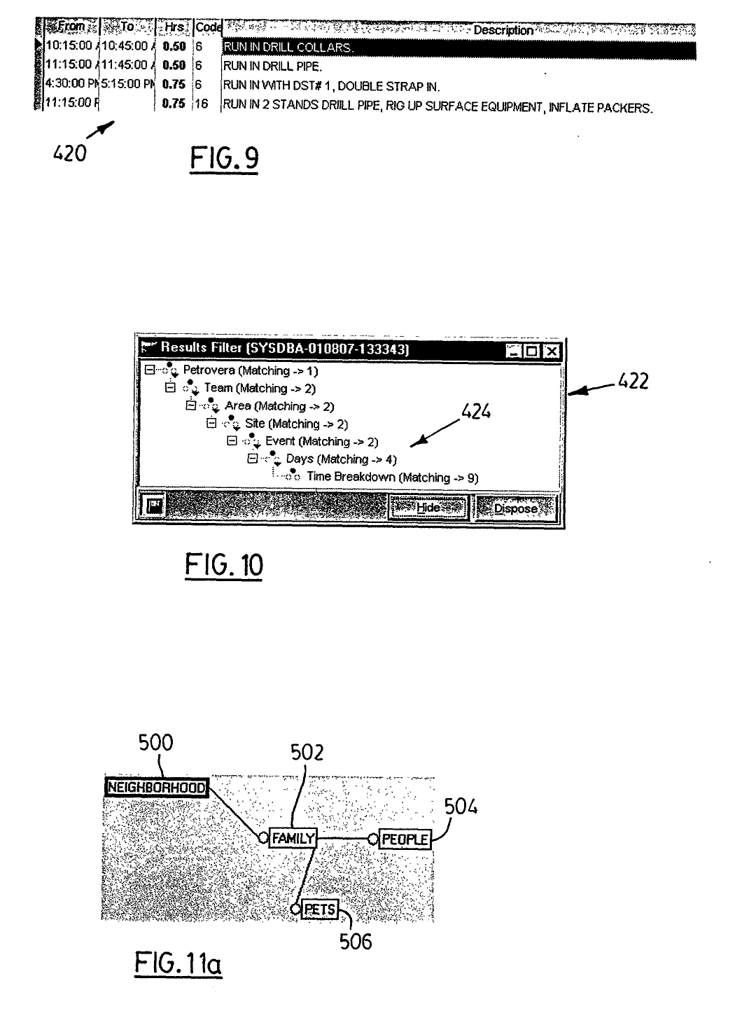

During execution of this query, the query arbiter 400 creates a query agent 402 for the query comparison to locate daily drilling report description entries having the value “run”. The query agent 402 in turn performs the query operation and returns a result set that includes the primary keys associated with all daily drilling report description entries having the value “run”. Following this, the query arbiter 400 creates a query agent 402 for the query root container. The query agent in turn grows the returned result set to the top of the hierarchical database. Once the result set has been grown to the top of the hierarchical database, the result set 406 is given to the query filter 408 and the query arbiter 400 is destroyed. FIG. 9 shows the description data control field of the daily drilling report document presenting only the database entries that satisfy the specified query. A filter window 422 is also opened (see FIG. 10) and displays the filters 424 that have been activated by the query filter 408 so that only the query results appear in the daily drilling report document that is presented in the active document panel 252 as shown in FIG. 9.

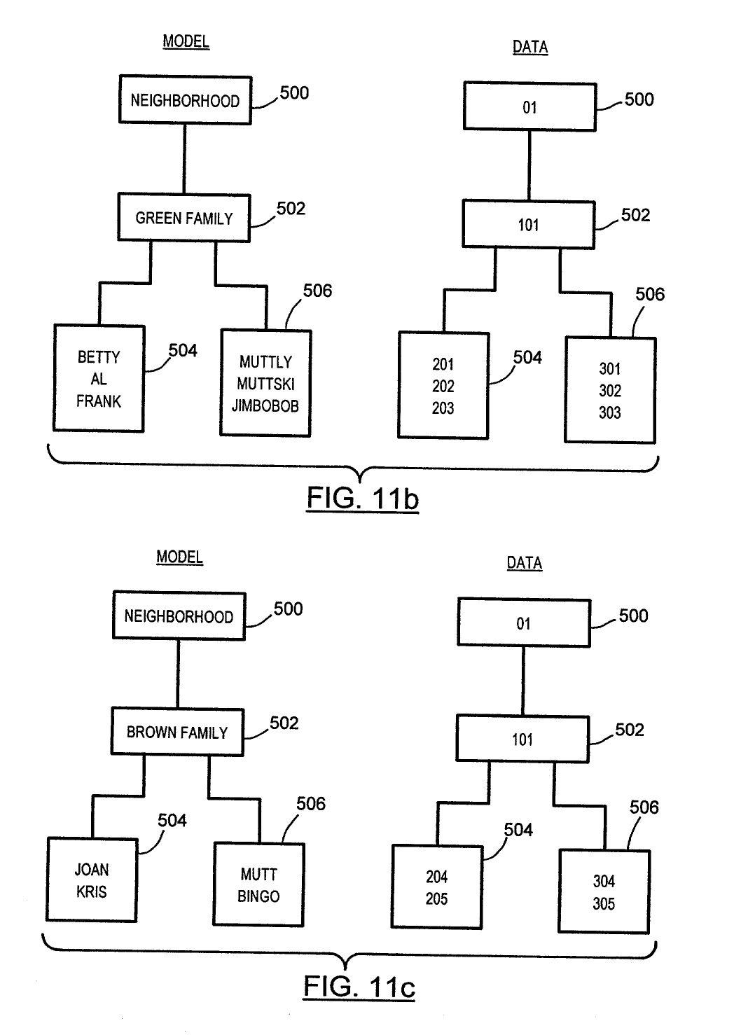

As mentioned previously with respect to step 364, depending on the type of search being performed across the hierarchical database, during execution of a query container, it may be necessary to equalize the result sets returned by the query container's children before the query container can be executed. An example of a query that requires result set equalization will now be described with reference to FIGS. 11a to 18.

FIG. 11a shows a visual model for a business entity that includes a neighborhood entity 500, a family entity 502, a people entity 504 and a pets entity 506. In this particular example, two families are listed in the database table assigned to the family entity 502, namely the Green family and the Brown family. Within the Green family, three individuals are listed in the database table assigned to the people entity 504 that is associated with the Green family, namely Betty, Al and Frank. Three pets are listed in the database table assigned to the pets entity 506 that is associated with the Green family, namely Muttly, Muttski and Jimbobob. Within the Brown family, two individuals are listed in the database table assigned to the people entity 504 that is associated with the Brown family, namely Joan and Kris. Two pets are listed in the database table assigned to the pets entity 506 that is associated with the Brown family, namely Mutt and Bingo. FIGS. 11b and 11c show the model for each family and the primary keys associated with the family database table entries.

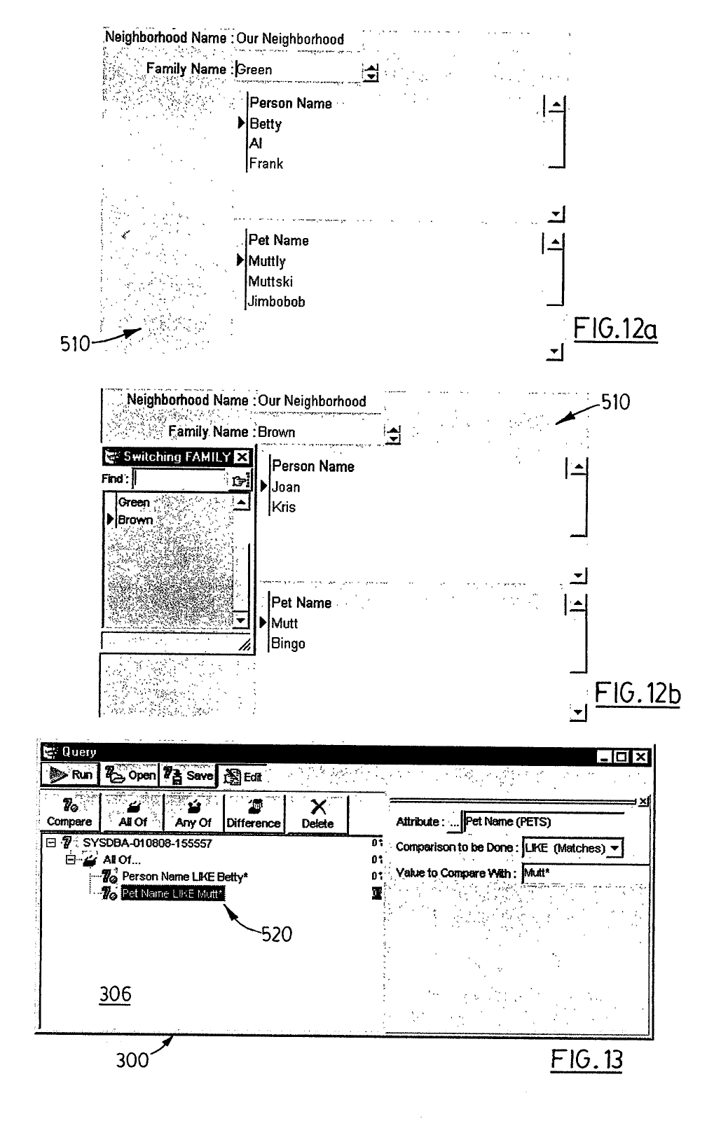

FIG. 12a shows a document 510 presented in the active document panel 252 of the workbook 250 that exposes the people and pet database entries associated with the Green family through appropriate data fields. FIG. 12b shows the document 510 where a drill-down control 512 has been used to expose the people and pet database entries associated with the Brown family.

FIG. 13 shows a query window 300 that specifies a query 520 to determine people who have names like “Betty” and who belong to a family that owns a pet whose name begins with “Mutt” in the query panel 306. In this example, the specified query 520 includes a query comparison to determine people who have names like “Betty”, a query comparison to determine pets who have names beginning with “Mutt”, a query intersection container to determine the intersection of the result sets returned by the above two query comparisons and a query root container.

When the specified query 520 is run, the query application tool 130 creates the query arbiter 400, which in turn examines the query operations in the specified query to determine the independent query operations. In this example, both query comparisons are independent. The query arbiter 400 then creates a query agent 402 for each query comparison and the query agents perform the query comparisons.

During performance of the query comparison for people who have names like “Betty”, the query agent 402 examines the database tables assigned to the people entities 504. In this case, the query agent 402 locates a single database entry in the database tables since only the database table assigned to the people entity 504 associated with the Green family includes a “Betty” entry. The primary key assigned to the “Betty” entry is saved in a container and forms the result set returned by the query agent 402. During performance of the query comparison for pets that have names beginning with “Mutt”, the query agent 402 examines the database tables assigned to the pets entities 506. In this case, the query agent 402 locates three database entries in the database tables since the database table assigned to the pets entity 506 associated with the Green family includes “Muttly” and “Muttski” entries and since the database table assigned to the pets entity 506 associated with the Brown family includes a “Mutt” entry. The primary keys assigned to the “Muttly”, “Muttski” and “Mutt” entries are saved in a container and form the result set returned by the query agent 402. FIG. 14 shows the result sets 520 and 522 returned by the query agents 402 and as will be appreciated, the containers 524 and 526 in the result sets 520 and 522 respectively include primary keys associated with different entities in the model of FIG. 11a.

When the result sets of the query comparisons are returned to the query arbiter 400 by the query agents 402, the query arbiter 400 checks to see if any dependent query operations exist. In this case, no dependent query operations exist. The query arbiter 400 then checks the query containers to determine query containers that perform query operations and that are ready to be executed. In this example, since the result sets from the two query comparisons are available, the query intersection container is ready for execution.

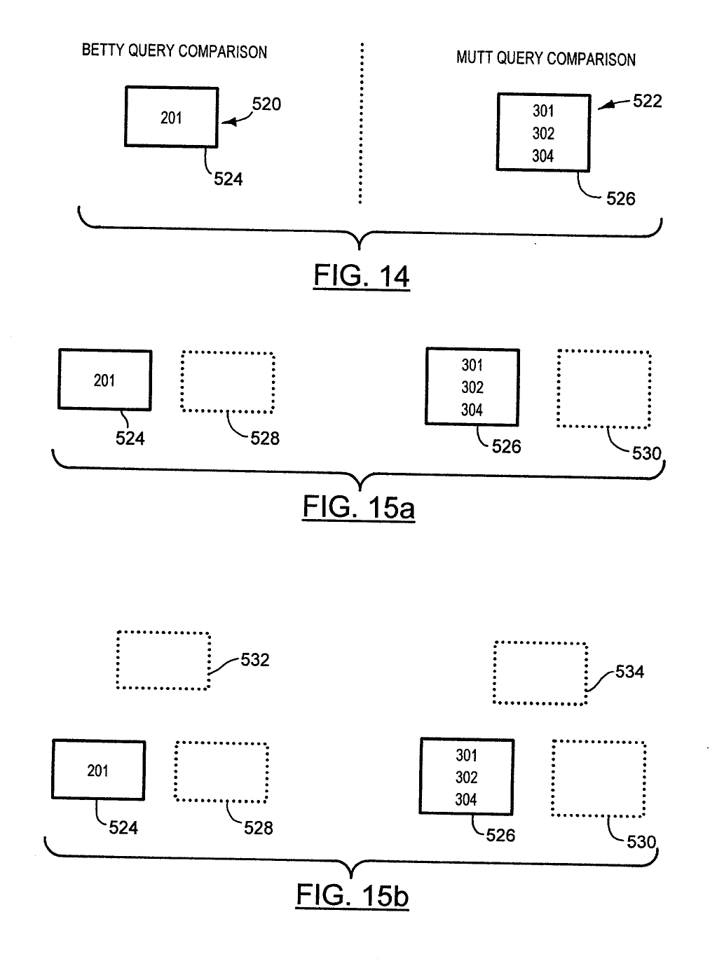

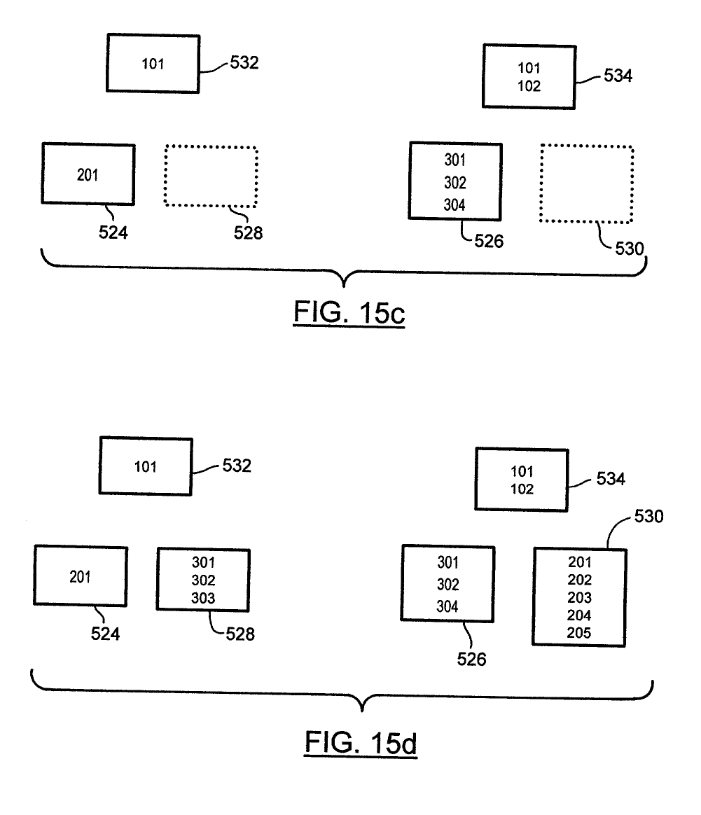

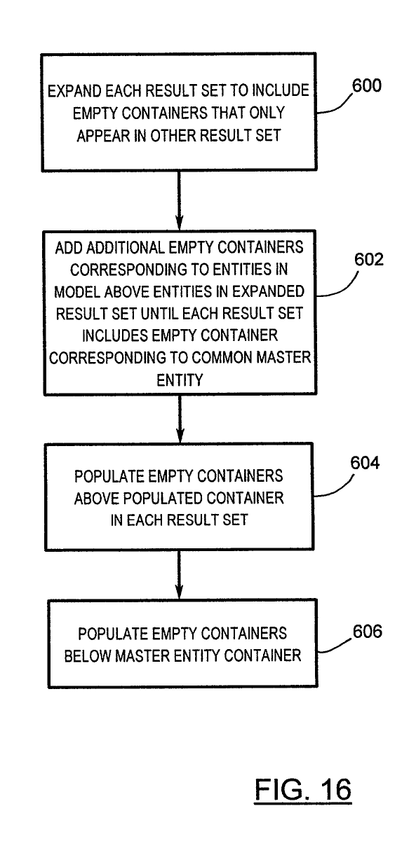

The query arbiter 400 then creates a query agent 402 for the query intersection container. In this case, since the result sets include primary keys associated with different entities in the model, to facilitate performance of the query intersection, the result sets are equalized before the query intersection is performed as will now be described with particular reference to FIGS. 15a to 15d and FIG. 16.

During equalization, initially each result set is expanded to include empty containers associated with entities that only appear in the other result set (see block 600 in FIG. 16). Thus, in this example an empty pets container 528 is added to the result set 520 and an empty people container 530 is added to result set 522 as shown in FIG. 15a. As a result, the two result sets 520 and 522 include the same containers. Additional empty containers corresponding to entities in the model above the entities in the expanded result sets 520 and 522 are then added until each result set includes an empty container that is associated with a common master entity (block 602). In the present example, during this step empty family containers 532, 534 are added to the result sets 520 and 522 respectively as shown in FIG. 15b.

At this stage for each result set, the empty containers above the populated container are then populated with primary keys by growing the populated containers upwardly towards the empty master container (block 604). This can be achieved since each entity in the model includes a key to its master entity. For example, the people entity 504 has the family entity 502 as a master entity. Thus, the database entry containing the “Betty” primary key includes the key to its master entity, namely the Green family. Therefore the primary key associated with the Green family is added to the family container 532 of the result set 520. With respect to the result set 522, the pets entity 506 has the family entity 502 as a master entity. Thus, the database entries containing the “Muttly”, “Muttski” and “Mutt” primary keys include the keys to their master entity, namely the Green family. The database entry containing the “Mutt” primary key includes the key to its master entity, namely the Brown family. Therefore the primary keys associated with the Green and Brown families are added to the family container 534 of the result set 522. The above steps are illustrated in FIG. 15c.

With the family container of each result set populated, the primary keys in the family containers are then used to populate the empty containers below the family containers (block 606). With the empty containers below the master containers populated, the result sets are equalized. In this example, the result set 520 includes an empty pets container 528. The family container 532 of the result set 520 having been populated includes the Green family primary key. This primary key is used to determine the database entries in the pets entity 506 of the Green family by matching it with the foreign primary key in the pets entity 506. In this case, the Green family pets include Muttly, Muttski and Jimbob. The primary keys assigned to these database entries are then used to populate the pets container 528 in the result set 520. The result set 522 includes an empty people container 530. The family container 534 of the result set 522 having been populated includes the Green and Brown family primary keys. These primary keys are used to determine the database entries in the people entities 504 of the Green and Brown families by matching them with the foreign primary keys in the family entity 504. In this case, the Green and Brown family people include Betty, Al, Frank, Joan and Kris. The primary keys assigned to these database entries are then used to populate the people container 530 in the result set 522. The above steps are illustrated in FIG. 15d.

With two result sets 520 and 522 equalized in this manner, the query arbiter 400 in turn creates a query agent 402. The query agent 402 performs the intersection of the two result sets and returns the result set to the query arbiter 400. Performing the intersection of the two equalized result sets is straightforward due to the fact that it is a simple case of comparing the primary keys in the result sets 520 and 522 to determine the common primary keys. In this example, the result set returned to the query arbiter 400 by the query agent 402 includes the primary key for Betty and the primary keys for “Muttly” and “Muttski” since these primary keys are common in the equalized results sets 520 and 522. With the result set returned by the query agent 402, the query arbiter 400 creates a query agent 402 for the query root container. The query agent 402 in turn grows the returned result set to the top of the hierarchical model.

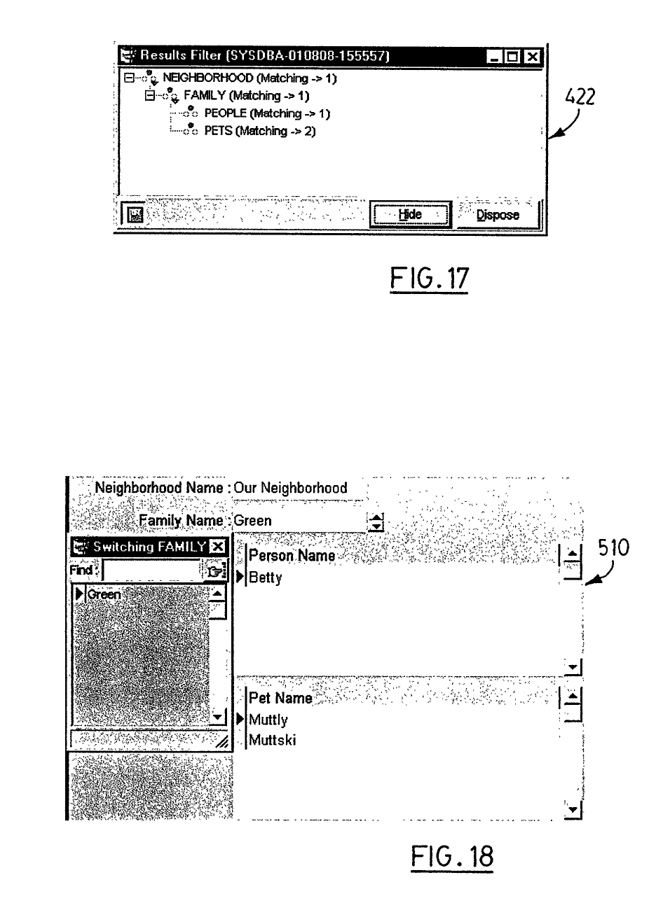

With the returned result set grown to the top of the hierarchical model, the query agent 402 returns the result set to the query arbiter 400. The query arbiter in turn passes the result set to the query filter 408 and the query arbiter 400 is destroyed. The query filter 408 in turn sets the appropriate filters so that the document 510 in the active document panel 254 only displays the query results. FIG. 17 shows the filter window 422 and the filters set by the query filter 408 so that only the database entries associated with the primary keys in the result set received by the query filter are exposed. FIG. 18 shows the document 510 displaying the query results.

Although the above example describes an intersection of the two result sets 520 and 522, once the result sets have been equalized other operations can easily be performed. For example, if a union of the result sets 520 and 522 is to be performed, the primary keys in both result sets are merged and saved in a container. If a difference between the result sets 520 and 522 is to be performed, the primary keys that are not common in the result sets are determined and saved in a container.

As will be appreciated by those of skill in the art, although the query application tool has been described with particular reference to the document-based database management system 100, the query application tool can of course be implemented in other environments where it is necessary to search hierarchical databases for information. The query application tool allows searches to be performed across database tables of a hierarchical database easily and provides query results in a manner that facilitates application and visualization of the query results. Since the query operations are driven using simple SQL statements the query application tool is independent of the database.

Although a preferred embodiment of the present invention has been described, those of skill in the art will appreciate that variations and modifications may be made without departing from the spirit and scope thereof as defined by the appended claims.

What is claimed is:

1. In a document-based database management system where data entries are stored in database tables of a database and wherein data entries are exposed through documents including data controls live linked to said database tables, a query application tool comprising:
a query arbiter responsive to a specified query to search the database tables for data entries that satisfy said specified query and generate query results; and
a query filter to restrict the display of data entries in an active document so that only data entries in said query result that correspond with data controls in said active document are displayed.

2. A query application tool according to claim 1 wherein said database is hierarchical and wherein said query filter generates filters relative to the hierarchy of said database to restrict the display of data entries.

3. A query application tool according to claim 2 further including a graphical user interface to display the generated filters.

4. A query application tool according to claim 3 wherein said graphical user interface presents said filters in a visual hierarchy to provide a visual indication as to the location of the query results within said hierarchical database.

5. A query application tool according to claim 4 wherein said displayed filters can be selectively disabled to allow additional data entries be exposed through said data controls in said active document.

6. A query application tool according to claim 5 wherein said displayed filters are selectively disabled and enabled using a computer-printing device.

7. A query application tool according to claim 2 wherein said query arbiter creates query agents to perform searches of said database tables.

8. A query application tool according to claim 7 wherein said specified query includes at least one query operation and at least one query container, said query arbiter firstly creating a query agent to execute said at least one query operation and generate a result set and then creating a query agent to execute said at least one query container and grow said result set to the top of the hierarchical database.

9. A query application tool according to claim 8 wherein when said specified query includes multiple query operations and multiple query containers, said query arbiter equalizes generated result sets, if necessary prior to executing said query operations and said query containers.

10. A query application tool according to claim 9 wherein each query operation includes an attribute, a logical operator and a qualifier.

11. A query application tool according to claim 10 wherein one of said query containers is a query root container and wherein the remaining query containers include query operations that require result sets from underlying query operations before being executable.

12. In a document-based database management system where data entries are stored in database tables of a database and wherein data entries are exposed through documents including data controls live linked to said database tables, a method of displaying data entries in said database tables that satisfy a specified query in an active document comprising the steps of:
examining a specified query and searching said database to locate data entries satisfying said specified query thereby to generate a query result;
generating filters to restrict the display of data entries to data entries in said query result; and
displaying data entries in said query result that correspond with data controls included in said active document.

13. The method of claim 12 further comprising the step of displaying the generated filters.

14. The method of claim 13 further comprising the step of selectively enabling and disabling generated filters.

15. A method of searching first and second result sets extracted from a hierarchical database for data entries in said database that satisfy search criteria, said method comprising the steps of:
equalizing said first and second result sets; and
examining said equalized first and second result sets based on said search criteria for data entries in said equalized first and second result sets that satisfy said search criteria.

16. The method of claim 15 wherein during said equalizing, said first and second result sets are expanded so that each result set includes data entries from database tables assigned to entities of said hierarchical database up to a common master entity.

17. The method of claim 16 wherein said expanding further comprises the steps of:
adding containers to said first result set corresponding to entities in the second result set not in said first result set and adding containers to said second result set corresponding to entities in the first result set not in said second result set;
adding containers to said first and second result sets until each result set includes a common master container; and
populating the added containers with appropriate data entries in said hierarchical database.

18. The method of claim 17 wherein the data entries in said first and second result sets are primary keys.

19. The method of claim 18 wherein during said searching, the primary keys in said first and second result sets determine the data entries that satisfy said search criteria.

20. The method of claim 19 wherein said search criteria includes one of an intersection, a union and a difference of said first and second result sets.

21. The method of claim 20 wherein during said intersection, primary keys common in both said first and second result sets determine the data entries that satisfy said search criteria, wherein during said union, primary keys in said first and second result sets determine the data entries that satisfy said search criteria, and wherein during said difference, primary keys common in both said first and second result sets determine the data entries that satisfy said search criteria.

22. A query filter to restrict the display of data entries stored in a hierarchical database that are live linked to data controls in an active document, said query filter comprising:
a plurality of filters generated in response to a query to restrict the display of data entries corresponding with data controls of said active document to those data entries that satisfy said query; and
a graphical user interface to display the generated filters.

23. A query filter according to claim 22 wherein said graphical user interface presents said generated filters in a visual hierarchical corresponding to the hierarchy of said database.

24. A query filter according to claim 23 wherein said graphical user interface permits said generated filters to be selectively enabled and disabled.
